(19) United States
(12) Patent Application Publication
(10) Pub. No.: US 2014/0012659 A1
(43) Pub. Date: Jan. 9, 2014

(54) MODIFYING TARGETING CRITERIA FOR AN ADVERTISING CAMPAIGN BASED ON ADVERTISING CAMPAIGN BUDGET

(71) Applicant: Rong Yan, Mountain View, CA (US)

(72) Inventor: Rong Yan, Mountain View, CA (US)

(21) Appl. No.: 13/544,880

(22) Filed: Jul. 9, 2012

(51) Int. Cl. G06Q 30/02

(52) U.S. Cl. 705/14.42; 705/14.48

(57) ABSTRACT

A social networking system modifies targeting criteria for an advertising campaign received form an advertiser using performance of completed advertising campaigns with similar characteristics. Completed advertising campaigns having similar targeting criteria to a received advertising campaign are identified. For example, completed advertising campaigns with targeting criteria matching, or associated with, targeting criteria from the received advertising campaign are identified. The social networking system determines an estimated amount to spend on the received advertising campaign based on the amount spent for the completed advertising campaigns, the social networking system. A received budget for the received advertising campaign is compared to the estimated amount to spend, and the social networking system may suggest modifications to the targeting criteria to optimize use of the budget based on performance of the completed advertising campaigns. The suggestion may be sent to an electronic device associated with the advertiser.

### BACKGROUND

This disclosure relates generally to advertising in a social network, and in particular to modifying targeting criteria for an advertising campaign in view of its budget.

Estimates suggest continued growth in Internet ad spending, as advertisers continue to shift to online media as a more effective way to reach consumers. Commonly, advertisers group advertisements (“ads”) into one or more ad campaigns that are used to advertise online. Advertisers commonly allocate a budget to an advertising campaign based on the amount of funds available to spend (e.g., some percentage of an overall ad budget), or based on a percentage of gross sales to reach an intended audience. To increase the likelihood that target users will be presented with ads from an advertising campaign, advertisers often associate targeting criteria with the advertising campaign or with ads in the advertising campaign. The targeting criteria identify one or more characteristics of users the advertiser desires to view an ad. Examples of targeting criteria include gender, age, interest, or some other demographic. For example, an advertiser may define targeting criteria specifying males and females, ages seventeen to twenty-four, college students, and purchased e-reader or tablet computing device within the last year to identify users who are presented an ad for electronic textbooks.

Often, for an advertising campaign to be effective, its budget should enable ads from the advertising campaign to reach their intended audience with sufficient frequency to prompt members of the audience to interact with the ads. However, if the budget for an advertising campaign is too high, the campaign's intended audience may be saturated with more advertisements than necessary to benefit the advertiser. Conversely, if the budget for an advertising campaign is too low, the advertiser does not sufficiently engage the campaign's intended audience, essentially expending resources to merely explore the effectiveness of the ad.

### SUMMARY

An advertising campaign includes one or more advertisements, as well as information describing presentation of the one or more advertisements. This information may include targeting criteria identifying characteristics of users to which an advertiser desires to present advertisements and a budget specifying an amount the advertiser is willing to spend to distribute advertisements in the advertising campaign. When an advertising campaign is received by a social networking system, the social networking system may analyze completed advertising campaigns to provide suggestions to an advertiser to more effectively use the advertising campaign budget to distribute advertisements. For example, the social networking system may suggest modifications to the targeting criteria to increase or decrease the number of users potentially presented with advertisements by comparing an advertisement campaign budget to amounts spent by completed advertising campaign with similar targeting criteria to the advertising campaign.

A social networking system identifies targeting criteria used in a received advertising campaign and identifies one or more completed, or historical, advertising campaigns associated with similar targeting criteria. For example, historical advertising campaigns having a specified number or percentage of targeting criteria matching the targeting criteria used in the received advertising campaign are identified. As another example, historical advertising campaigns associated with a specified number or percentage of targeting criteria related to, or associated with, targeting criteria used in the received advertising campaign are identified. An amount spent is determined from the one or more historical advertising campaigns having similar targeting criteria to the received advertising campaign. In some embodiments, a performance metric is used to identify a subset of the historical advertising campaigns used to determine the amount spent. This may allow the amount spent to be determined from historical advertising campaigns having at least a threshold level of performance to provide a more beneficial amount spent. The social networking system may determine the amount spent by calculating a mean or median of the amounts spent by the one or more comparable historical advertising campaigns.

The budget of the received advertising campaign is compared to the amount spent, with the comparison used to suggest modifications to the advertising campaign's targeting criteria to increase or decrease the users to potentially view advertisements from the advertising campaign. For example, if the advertising campaign's budget exceeds the amount spent, a suggestion to broaden the advertising campaign's targeting criteria is generated. Similarly, if the advertising campaign's budget is less than the amount spent, a suggestion to narrow the advertising campaign's targeting criteria may be generated.

### BRIEF DESCRIPTION OF THE DRAWINGS

FIG. 1 illustrates a high level block diagram of a computing environment for modifying targeting criteria for an advertising campaign based on a budget for the advertising campaign, in accordance with an embodiment.

FIG. 2 illustrates a high level block diagram of a social networking system in further detail, in accordance with an embodiment.

FIG. 3 illustrates a high level block diagram of ad targeting module of a social networking system in further detail, in accordance with an embodiment.

FIG. 4 illustrates a flowchart of a process for modifying targeting criteria for targeted ads based on a predicted ad spend for the ads, in accordance with an embodiment.

The Figures depict various embodiments for purposes of illustration only. One skilled in the art will readily recognize from the following discussion that alternative embodiments of the structures and methods illustrated herein may be employed without departing from the principles of this disclosure.

### DETAILED DESCRIPTION

### Overview

A social networking system offers its users the ability to communicate and interact with other social networking system users. Users join the social networking system and add connections to a number of other users to whom they desire to be connected. Users may be an individual or any other entity, such as a business or other non-person entity. Social networking system users share with the social networking system information describing them. For example, users share age, gender, geographical location, education history, employment history and the like. The social networking system, in turn, uses this information to enable users to become more socially connected with information, causes, goods, and services relevant to their interests.

For an advertiser, the increased user connectivity provided by a social networking system allows the advertiser to leverage data maintained by the social networking system, subject to social networking system privacy settings, to distribute advertisements (“ads”) to a greater number of parties. For example, data maintained by a social networking system allows an advertiser to more effectively use targeting criteria to identify social networking systems likely to be interested in an ad. Advertisers may group ads into advertising campaigns having targeting criteria, so that ads from an advertising campaign are shown to social networking system users having one or more criteria defined by the targeting criteria. An advertising campaign may also include a budget, allowing an advertiser to allocate resources among different advertising campaigns. To aid advertisers in managing the expense of targeting ads to users, the social networking system may use data stored from the prior advertising campaigns to suggest modifications to an advertising campaign based on the targeting criteria and budget of the advertising campaign.

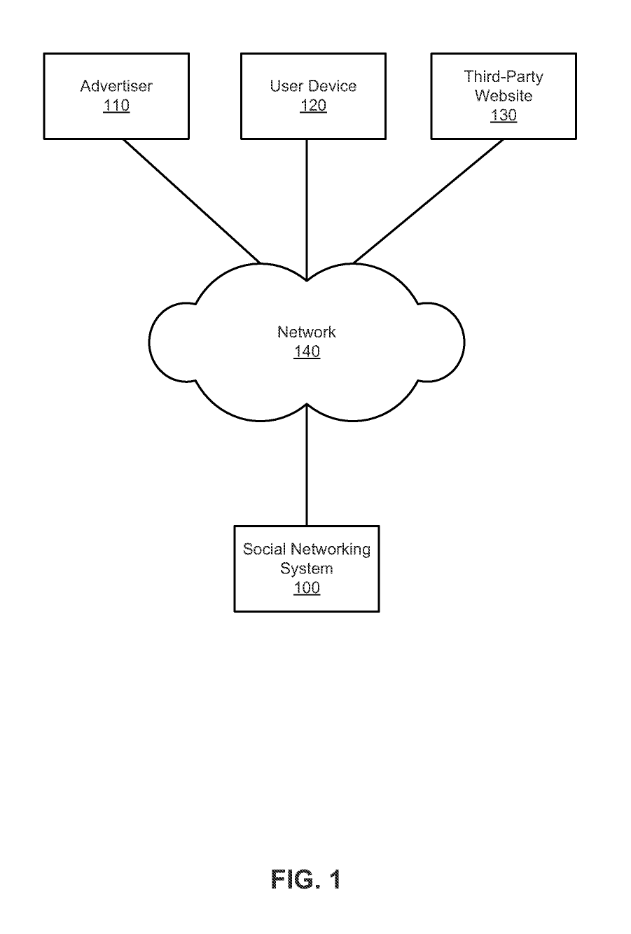

FIG. 1 illustrates a high level block diagram of one embodiment of a computing environment for modifying targeting criteria for an advertising campaign based on a budget for the advertising campaign. The computing environment shown by FIG. 1 includes social networking system 100, advertiser 110, user device 120, content provider 130, and network 140. Social networking system 100 serves ads received from advertiser 110 to user device 120 in exchange for compensation from advertiser 110. For example, advertiser 110 financially compensates social networking system 100 for serving ads from advertiser 110. In one embodiment, content provider 130 may also compensate social networking system 100 for providing content from content provider 130 to user device 120. Social networking system 100 provides content, such as ads from advertiser 110 and content from content provider 130, to user 120 over network 140. Social networking system 100 also provides content maintained by social networking system 100 to user device 120. For example, social networking system 100 provides user device 120 with data describing characteristics of social networking system users and/or actions performed by social networking system users.

The social networking system 100 stores information about users, objects, and the connections among and between users and objects. Stored information about users includes biographic, demographic, and other types of descriptive information. Stored information about objects includes information about a variety of things with which a user of social networking system 100 may interact in social networking system 100, including: other users, application objects, event objects, group objects to which users may belong, page or hub objects, media item objects, and location objects associated with a user. Other information stored about objects includes information routinely produced by users of social networking system 100, such as message objects, status updates, photos, and videos. Stored information about connections among and between users and objects includes data about connections between users (e.g., familial relationship), between objects (e.g., pages) and users, and affinity scores for objects, interests, and other users. Other stored information about connections describes interactions among users (e.g., sharing a link, tagging a user in an image, commenting on a post, etc.) and/or objects (e.g., listening to an audio object or viewing a video from a video object on a page).

In an embodiment, social networking system 100, and content provider 130 are a single system and/or are administered by the same organization. For example, social networking system 100 includes content provider 130, allowing social networking system 100 to provide a variety of content to user device 120. In an embodiment, social networking system 100 serves ads from advertiser 100 to user device 120 based on targeting criteria defined by advertiser 110 and received from social networking system 100. For example, social networking system 100 receives an advertising campaign including ads, targeting criteria, and a budget. The targeting criteria identify one or more characteristics of users to whom advertiser 110 desires to be served an ad from the advertising campaign. For example, social networking system 100 determines a predicted amount to be spent by an advertiser during a received advertising campaign based on amounts spent during one or more historical advertising campaigns (also referred to as “ad spend”) or determines the historical ad spend for advertising campaigns having similar targeting criteria and suggests modifications to the initial targeting criteria based on the advertising campaign's budget, the advertising campaign's targeting criteria and the predicted ad spend or historical amount spent.

User device 120 is a computing device having data processing capabilities as well as the capability to communicate over network 140. Examples of computing devices include personal computers, mobile phones, smart phones, laptop computers, tablet computers, and digital televisions, television set-top boxes, media player with functionality to communicate over network 140. User device 120 may be used by an individual or any suitable entity, such as a business or other non-person entity, to exchange data with social networking system 100 and/or third-party website 130.

Network 140 includes devices linked together using wired and/or wireless connections facilitate communication between social networking system 100, advertiser 110, user device 120, and third-party website 130. In an embodiment, network 140 includes the Internet. In an embodiment, network 140 includes a LAN, a MAN, a WAN, a mobile, a wired or a wireless network, a private network, or a virtual private network.

Third-party website 130 is any system providing content to user device 120 and/or social networking system 100. For example, third-party website 130 may be a video hosting service, a blogging website, an image hosting website or other suitable content provider. In one embodiment, third-party website 130 communicates with social networking system 100 via network 140 so that a combination of content from third-party website 130 and data from social networking system 100 is communicated to user device 120. For example, a user associated with user device 120 is presented content from third-party website 130 in addition to comments or other data from users of social networking system 100 associated with the presented content.

Advertiser 110 is a business, organization or other entity providing ads to user device 120 and/or other computing devices via network 140. For example, advertiser 110 distributes ads to user device via social networking system 100 and network 140. Advertiser 110 generates an ad campaign including one or more ads, targeting criteria and a budget. The targeting criteria identify one or more characteristics of users of social networking system 100 to whom ads in the advertising campaign are presented (also referred to as “served” herein).

In an embodiment, advertiser 110 implicitly specifies the targeting criteria based on a lack of specified criteria (e.g., the value “All users,” an implicit criterion resulting from the advertiser failing to specify any explicit targeting criteria). Alternatively, advertiser 110 specifies one or more characteristics of users of social networking system 100 via targeting criteria. Examples of user characteristics specified by targeting criteria include user attributes, connection types between users and/or other objects, event attendance, indication of event attendance or other suitable data describing users. Examples of user attributes included in targeting criteria include user age, gender, geographic location, interests, languages spoken, education level, relationship status, and the like. Targeting criteria may specify connection types between users and/or other objects. For example, connection types include relationship data from a social graph of social networking system 100 (e.g., the number of friends, or the attributes of the friends), actions taken by a user outside of social networking system 100 (e.g., web pages viewed) or actions within a social networking system (e.g., items for which the user expressed approval or “liked,” groups belonged to, goods or service purchased, etc.).

The targeting criteria may include attributes of content presented by social networking system 100 in conjunction with the ads. For example, the targeting criteria may specify keywords or topics associated with the content, such as “cycling” or “golf.” In one example, content providers specify keywords or topics as metadata of web pages presenting the content. In another example, content providers infer keywords by applying classifier models generated through machine learning processes that label content with topics or keywords. These keywords or topics are compared to the targeting criteria to determine whether to serve ads from the advertising campaign when the content is accessed by a user.

In an embodiment, data stored by social networking system 100 is compared to targeting criteria to identify users of social networking 100 having one or more of the identified characteristics (“users satisfying the targeting criteria”). For example, social networking system 100 accesses stored user profile data to identify users satisfying the targeting criteria. In one embodiment, access to user profiles is regulated by one or more user-specified privacy settings regulating information in the user profile that may be used. Alternatively, social networking system 100 infers user characteristics based on the user's interactions with other users of social networking system 100 and/or other objects. For example, social networking system 100 infers user characteristics based content viewed by the user, characteristics of other users to whom the user is connected, indications of preference for social networking system objects, and the like.

The budget describes an amount of resources advertiser 110 allocates to the advertising campaign by identifying a total amount advertiser 110 allocates for compensating social networking system 100. In one embodiment, advertiser 100 compensates social networking system 100 when social networking system 100 serves an ad from the advertising campaign to a user of social networking system 100. Advertiser 110 may specify payment conditions for individual advertisements in an advertising campaign or for the advertising campaign as a whole. Example payment conditions include: displaying an ad from the advertising campaign to a user satisfying the targeting criteria, a user accessing an ad from the advertising campaign, a user purchasing a product associated with an ad from the advertising campaign, a user responding positively to a poll associated with the ad or advertiser 100 or the like. When the budget is exhausted, advertiser 110 does not continue to compensate social networking system 100 for presenting ads from the advertising campaign.

Hence, social networking system 100 receives and stores advertising campaign data from advertiser 110, identifies users of social networking system 100 satisfying the targeting criteria for an advertising campaign and serves ads from the advertising campaign to users satisfying the targeting criteria. Social networking system 100 may also store data describing historical, or completed, advertising campaigns. For example, social networking system 100 stores targeting criteria used by historical advertising campaigns, budgets for historical advertising campaigns, an amount spent by advertiser 100 during a historical advertising campaign (i.e., ad spend), and ad performance metrics.

Example ad performance metrics include impressions, social impressions, social percentage, clicks, social clicks, click-through-rate (CTR), social CTR, actions, action rate, conversions, cost-per-conversion, cost-per-click, cost per thousand impressions (CPM), ad spend, unique click, unique CTR, or other information describing presentation of an ad along with content from social networking system 100. Impressions indicate a total number of times that an ad was presented to users. Social impressions indicate the frequency with which the ad was shown along with social context users connected to a viewing user and to an object associated with advertiser 110. Social clicks indicate the number of clicks received from an ad with a social context. Click-through rate indicates the percentage of the time that users accessed the ad relative to a number of times the ad was served or a frequency of unique delivery indicating the number of unique users served the ad. Social CTR indicates the number of social clicks divided by the number of social impressions. Actions indicate the number of users of social networking system 100 that took a desired action from the ad.

Social networking system 100 may access historical advertising campaign data when an advertising campaign is received from advertiser 100 and provide suggestions to advertiser 110 for modifying the advertising campaign based on the historical advertising campaigns. For example, social networking system 100 compares the budget for the advertising campaign to the amount spent on historical advertising campaigns having similar targeting criteria. In one embodiment, social networking system 100 suggests broadening the targeting criteria for the advertising campaign if its budget is larger than an amount spent derived from information about the historical advertising campaigns having similar targeting criteria and vice versa. Social networking system 100 may also suggest modifications to the targeting criteria to broaden the advertising campaign's targeting criteria or to narrow the advertising campaign's targeting criteria. This allows social networking system 100 to leverage its stored data to allow advertiser 100 to more effectively use the advertising campaign's budget.

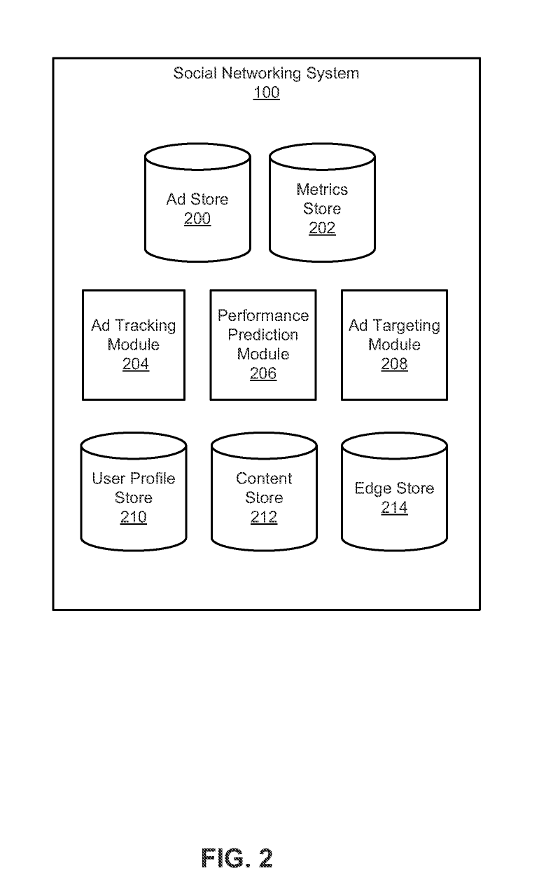

FIG. 2 illustrates a high level block diagram of social networking system 100 in further detail, in accordance with an embodiment. Social networking system 100 includes data describing users and objects as well as connections between users or objects and other users or objects in user profile store 210, content store 212 and edge store 214. User account information and other related information for users are stored as user profiles in the user profile store 210. The user profile information stored in user profile store 210 describes the users of social networking system 100, including biographic, demographic, and other types of descriptive information, such as work experience, educational history, gender, hobbies or preferences, location, and the like. User profile store 210 may also store other information provided by the user, for example, images or videos. In certain embodiments, images of users may be tagged with identification information of users of social networking system 100 displayed in an image. User profile store 210 also maintains references to the actions stored in an action log (not shown) and performed on objects in content store 212.

Content store 212 stores content items associated with a user profile, such as images, videos and audio files. Content items from the content store 212 may be displayed when a user profile is viewed or when other content associated with the user profile is viewed. For example, displayed content items may show images or videos associated with a user profile or show text describing a user's status. Additionally, other content items may facilitate user engagement by encouraging a user to expand his connections to other users, to invite new users to the system or to increase interaction with social networking system 100 by displaying content related to users, objects, activities, or functionalities of social networking system 100. Examples of social networking content items include suggested connections or suggestions to perform other actions, media provided to, or maintained by, social networking system 100 (e.g., pictures or videos), status messages or links posted by users to social networking system 100, events, groups, pages (e.g., representing an organization or commercial entity), and any other content provided by or accessible via social networking system 100.

Content store 212 may also include one or more third-party pages associated with user profiles of entities. A third-party page comprises content associated with the entity and instructions for presentation of the content to a user of social networking system 100. For example, a third-party page identifies content associated with the entity's user profile as well as information describing how to present the content to users viewing the third-party page.

Edge store 214 stores the information describing connections between users and other objects on social networking system 100. Some edges may be defined by users, allowing users to specify their relationships with other users. For example, users may generate edges with other users that parallel the users' real-life relationships, such as friends, co-workers, partners, and so forth. Other edges are generated when users interact with objects in social networking system 100, such as expressing interest in a page on social networking system 100, sharing a link with other users of social networking system 100, and commenting on posts made by other users of social networking system 100. Edge store 214 stores edge objects that include information about the edge, such as affinity scores for objects, interests, and other users. Affinity scores may be computed by social networking system 100 over time to approximate a user's affinity for an object, interest, and other users in social networking system 100 based on the actions performed by the user. Multiple interactions between a user and a specific object may be stored in one edge object in edge store 214, in one embodiment.

Additionally, social networking system 100 comprises one or modules and data stores (e.g., databases) for receiving ads and advertising campaigns from advertiser 110 and for serving ads to users satisfying the advertising campaign's targeting criteria. Social networking system 100 may also store data describing historical, or completed, advertising campaigns and analyze the historical advertising campaigns to provide advertiser 110 with suggestions for more effectively using an advertising campaign's budget. Accordingly, in some embodiments, social networking system 100 includes ad store 200, metric store 202, ad tracking module 204, performance evaluation module 206, and ad targeting module 208.

Ad store 200 stores ads and data describing one or more advertising campaigns specified by advertiser 110. Additionally, ad store 200 includes ads and associated data for ads served by social networking system 100. For ads that have been served to users, ad store 200 includes a reference to performance data in metrics store 202 associated with the served ads.

Ads may have different types, including textual ads, image ads, or video ads. An ad, or data associated with the ad, may also include data describing presentation of the ad. Examples of data describing presentation of the ad include display and/or formatting requirements, presentation of the ad relative to additional content (e.g., in a page banner, in a sidebar, as a link in a set of search results, etc.) or other data describing how the ad is presented to a user of social networking system 100. As described above, an advertising campaign also includes targeting criteria and a budget. The advertising campaign also includes a bid price for ads in the advertising campaign and conditions upon which advertiser 110 pays social networking system 100. Conditions of payment include a user clicking on the ad or other suitable performance metrics.

An advertising campaign may also include additional information, such as a description of the advertising campaign or a description of ads in the advertising campaign. Additional examples of information included in an advertising campaign include offer code, whisper code, offer expiration information or other offer information.

Metrics store 202 receives performance information from ad tracking module 204 for ads served to users by social networking system 100 and logs one or more performance metrics for the served ads. The performance metrics may be associated with an individual ad from an ad campaign or the ad campaign as a whole. For example, a performance metric of an ad quantifies the effectiveness of the ad. Performance metrics of an ad may quantify different aspects of an ad's effectiveness. Example performance metrics of an ad include those described with FIG. 1, including impressions, social impressions, social percentage, clicks, social clicks, CTR, social CTR, actions, action rate, conversions, cost-per-conversion, cost-per-click, CPM, ad spend, unique click, unique CTR, or other information describing presentation of an ad along with content from social networking system 100. Performance metrics of an ad campaign may include the amount of budget used and the remaining budget for each ad, and the percentage spend of the ad campaign budget indicating how much budget was consumed versus the entire ad campaign budget used to serve the ad in accordance the targeting criteria and other campaign conditions defined by advertiser 110.

Ad tracking module 204 tracks statistics associated with ads included in the ad store 200. Examples of tracked statistics include: the number of times an ad is served, the number of total impressions for each ad, the number of impressions required for each ad to reach an impression goal set by the advertisers, actions taken by viewers associated with each ad, and any other information associated with the ads, the display of the ads, and the goals and constraints set by advertiser 110. Ad tracking module 204 computes performance information and other metrics associated with the display of each ad based on captured interactions with ads, which are stored in metrics store 202 for archiving.

Performance evaluation module 206 retrieves data from ad store 200 and metrics store 202 and uses the retrieved data to evaluate a received advertising campaign in view of historical advertising campaign. Based on the evaluation, the performance evaluation module 206 may recommend changes to the advertising campaign's targeting criteria. In one embodiment, performance evaluation module 206 uses data from historical advertising campaigns having targeting criteria similar to the advertising campaign to evaluate the advertising campaign. For example, the performance evaluation module 206 determines an amount spent by the historical advertising campaigns and compares the advertising campaign budget to the historical advertising campaigns. If the budget is larger than the amount spent, performance evaluation module 206 may suggest broadening the targeting criteria for the advertising campaign so a larger number of users are served ads. If the budget is smaller than the amount spent determined from the historical advertising campaigns, performance evaluation module 206 may suggest narrowing the targeting criteria for the advertising campaign so a fewer number of users are served ads.

In another embodiment, performance evaluation module 206 may predict the ad spend for the advertising campaign based in part on its targeting criteria and its budget relative to an amount spent during historical advertising campaigns having similar targeting criteria or to budgets or historical advertising campaigns having similar targeting criteria. From the predicted ad spend, performance evaluation module 206 may suggest modification of targeting criteria to more efficiently use the advertising campaign's budget. For example, performance evaluation module 206 may suggest narrowing the advertising campaign's targeting criteria because the proposed budget is predicted to be too small to serve the initially targeted group. As another example, performance evaluation module 206 may suggest broadening the initial targeting criteria for the advertising campaign because the proposed budget is predicted to be too large for the initially targeted group, which may result in saturating the targeted group with the ad.

To evaluate a received advertising campaign, performance evaluation module 206 receives initial targeting criteria and a proposed budget for an advertising campaign from ad store 200, as well as historical advertising campaign information from ad store 200 and/or metrics store 202. A historical advertising campaign may be an advertising campaign that has been completed, an advertising campaign whose budget has been exhausted or another suitable advertising campaign. Historical advertising campaign information includes a campaign identifier, identifiers associated with ads in the campaign, targeting criteria, a budget, an amount of the budget used, an amount of the budget remaining unused or other data describing the advertising. In an embodiment, a third-party, such as a marketing analytics service, also provides historical ad information to social networking system 100 for performance evaluation module 206.

Performance evaluation module 206 analyzes performance metrics of served advertisements, such as conversion rates and other performance metrics described above in conjunction with FIG. 1. Performance evaluation module 206 uses this information to predict ad spend for an advertisement to be served based on the performance metrics associated with served ads having targeting criteria comparable to the target ad. For example, performance evaluation module 206 performs a regression analysis to predict ad spend for a targeted ad based on performance metrics, such as amount of budget consumed and amount of budget remaining for a served ad, and the frequency that the ad was served to a unique user.

In another example, performance evaluation module 206 analyzes a targeted audience versus the proposed budget for a served ad. For example, performance evaluation module 206 communicates with ad targeting module 208 to make an initial determination of the size of the audience targeted based on initial targeting criteria for an advertising campaign and evaluates whether the budget of the advertising campaign is sufficient to serve the ad to the targeted audience. To make the initial determination, performance evaluation module 206 accesses information about ad spend and ad campaign budget versus the audience size for historical campaigns from ad store 200, and compares this accessed information to that of the advertising campaign to be served. Based on the comparison, performance evaluation module 206 determines whether the budget for the advertising campaign to be served is sufficient for serving ads to the target audience. In determining sufficiency of the budget, performance evaluation module 206 may access data for historical advertising campaigns having similar targeting criteria, and obtain data about audience size, ad spend and campaign budget from the historical advertising campaigns with similar targeting criteria.

For example, a first historical advertising campaign having similar targeting criteria to the advertising campaign to be served may have a campaign budget of $100 USD and an ad spend of $80 USD to serve a target audience of 10,000 unique views. A second historical campaign having a similar targeting criteria as the ad to be served may have a campaign budget of $100 USD an ad spend of $100 USD to serve a target audience of 10,000 views. From this information about the first and second the second historical ad campaigns, performance evaluation module 206 may determine that a campaign budget of $80 USD is sufficient to serve an ad an audience size of 10,000 views because the data from the first and second historical campaigns indicates that the additional $20 USD ad spend used in the second historical campaign did not yield more views compared to the ad spend used in the first historical campaign.

In another example, performance evaluation module 206 analyzes the type of targeting for identifying users who are served ads in view of the advertising campaign's budget. Examples of targeting type include: demographic, interest, action, keyword, connection or other suitable data for identifying users. In a further example, performance evaluation module 206 identifies historical advertising campaigns having targeting criteria comparable to the advertising campaign, and analyzes the performance metrics of those historical advertising campaigns to predict the ad spend for the advertising campaign. Performance metrics analyzed by performance evaluation module 206 may include the metrics described above in conjunction with FIG. 1, including average CTR, average frequency of unique delivery, percentage of budget consumed or other suitable metrics describing performance of a historical advertising campaign.

Ad targeting module 208 obtains targeting criteria for ads and/or advertising campaigns from ad store 200. In an embodiment, ad store 200 receives targeting criteria from advertiser 110 through a user interface provided by social networking system 100. Alternatively, at targeting module 208 receives targeting criteria from advertiser 110. In one embodiment, ad targeting module 208 receives a suggested modification to an advertising campaign's targeting criteria from performance evaluation module 206 and generates modified targeting criteria, which are sent to advertiser 110 along with the suggestion. For example, ad targeting module 208 identifies additional targeting criteria for narrowing targeting criteria initially used by the advertising campaign or identifies targeting criteria for removal from the initially-used targeting criteria to broaden the targeting criteria for the advertising campaign.

Ad targeting module 208 suggests modifications to an advertising campaign's targeting criteria based at least in part on the evaluation of the advertising campaign in view of historical advertising campaigns by performance evaluation module 206. For example, based on a suggestion that the targeted audience is too small relative to the budget for serving an ad for “A weekend in the wine country,” ad targeting module 208 selects targeting criteria for broadening the initial set of targeting criteria. In the preceding example, ad targeting module 208 may broaden the targeting criteria by removing criteria and/or modifying criteria (e.g., expanding a geographic range of where targeted users live and/or work). Similarly, in another example, based on a suggestion that the targeted audience is too large relative to the budget for serving the preceding example ad, ad targeting module 208 narrows the initial targeting criteria. For example, ad targeting module 208 identifies additional criteria for inclusion in the initial targeting criteria and/or identifies modifications to the targeting criteria to limit the number of users satisfying the targeting criteria.

In one embodiment, ad targeting module 208 also sends advertiser 110 a request for confirming suggested modifications to the initial targeting criteria for an advertising campaign. If ad targeting module 208 receives a confirmation, it uses the modified targeting criteria to identify users that are served ads from the advertising campaign. In an embodiment, ad targeting module 208 may provide advertiser 110 with alternative modifications to the initial targeting criteria for the advertising campaign responsive to advertiser 110 disregarding or otherwise not confirming the suggested modifications. Alternatively, ad targeting module 208 may receive targeting criteria modified by the advertiser 100. Ad targeting module 208 may use the modified targeting criteria form advertiser 110 to identify users or may send the advertiser-supplied modified targeting criteria to performance evaluation module 206 for evaluation as previously described.

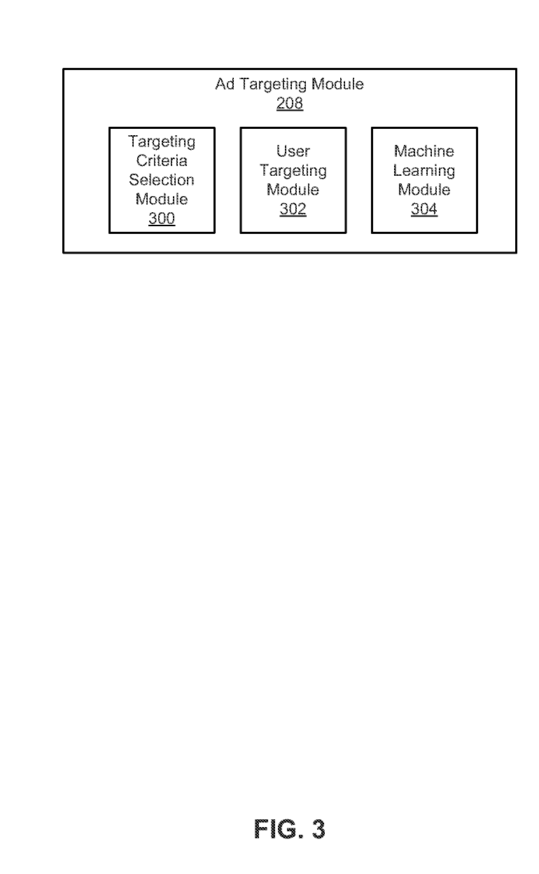

FIG. 3 shows a block diagram of an embodiment of an ad targeting module 208. Ad targeting module 208 includes targeting criteria selector 300, user targeting module 302, and machine learning module 304. These modules operate in conjunction with each other and/or independently to generate a suggestion for modifying initial targeting criteria for an advertising campaign. In one embodiment, modifications to the initial targeting criteria are based on a predicted ad spend for the advertising campaign determined in part from the amount spent by historical advertising campaigns or based on the amount spent by historical advertising campaigns with similar targeting criteria.

Targeting criteria selection module 300 selects and suggests targeting criteria to advertiser 110. Targeting criteria selection module 300 receives targeting criteria from advertiser 110 or from ad store 200 and identifies modifications to the targeting criteria to vary the number of social networking system users satisfying the targeting criteria. In one embodiment, the modifications to the targeting criteria are based on data from performance evaluation module 208. This allows the targeting criteria selection module 300 to modify targeting criteria for an advertising campaign to more effectively use the advertising campaign's budget based on analysis by the performance evaluation module 208.

In one embodiment, targeting criteria selection module 300 also analyzes the content of an advertisement (“ad”) from ad store 200 and infers targeting criteria from the content of the ad. For example, targeting criteria selection module 300 infers targeting criteria from the content of the advertisement by capturing characteristics of the advertisement and mapping those characteristics to users or user segments. In some embodiments, targeting selection module 300 uses a machine learning process, or another suitable process, to perform the mapping. Targeting criteria selection module 300 may also group targeting criteria based on the type of characteristic specified by the targeting criteria. For example, targeting criteria selection module 300 groups the targeting criteria into groups for demographic information, temporal information, geographic information, connection type, device type, entity type or any other suitable category.

User targeting module 302 identifies users having one or more characteristics identified by targeting criteria. For example, user targeting module 302 accesses user profiles for social networking system users and determines whether the user profile includes data matching one or more of the characteristics specified by the targeting criteria. Examples of user profile data compared to targeting criteria include: demographic information, location information, interests, preferences, connections to other users, interactions with other users or other data maintained by social networking system 100 and associated with a privacy setting allowing access to the data.

Machine learning module 304 operates in conjunction with targeting criteria selection module 300 to select targeting criteria and/or to modify targeting criteria, as previously described. In one embodiment, machine learning module 304 also operates in conjunction with performance evaluation module 206 to perform regression analysis to predict ad spend for an advertising campaign based on performance, budget and/or amount spent for historical advertising campaigns with similar targeting criteria to the advertising campaign. For example machine learning module 304 predicts performance metrics providing an indication of the optimal ad spend for a target ad based on a given targeting criteria. Machine learning module 304 may applies algorithms to predict CTR, frequency of unique delivery, ad spend versus brand lift, or any other metric in view of targeting criteria.

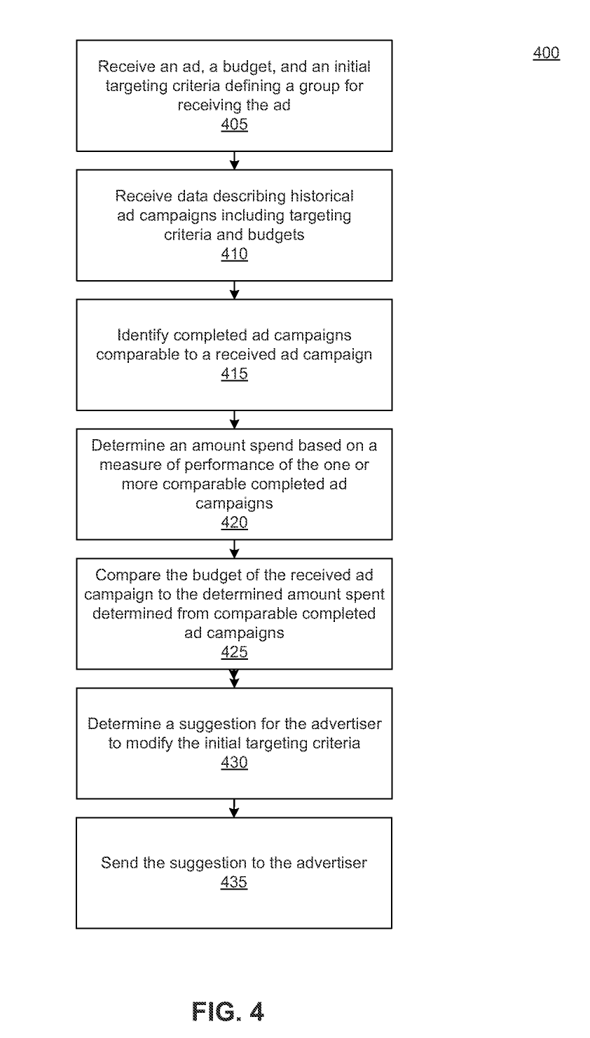

FIG. 4 illustrates a flowchart of one embodiment of a process 400 for modifying targeting criteria for targeted ad campaigns based on a predicted amount spent for the ad campaigns. Social networking system 100 receives 405 information describing an advertising campaign from an advertiser 110. The information may include one or more ads, a budget, and an initial targeting criteria defining one or more characteristics of users of a social networking system to receive one or more ads in the advertising campaign. In one embodiment, social networking system 100 receives 405 the information via an interface, such as a web-based interface, for exchanging data with advertiser 110. The interface also includes an application programming interface (API) through which advertiser 110 may create an ad or ad campaign, and specify targeting criteria, ad budget, and other campaign information.

Social networking system 100 retrieves 410 data stored by social networking system 100 describing historical advertising campaigns includes information about targeting criteria and budgets for completed advertising campaigns. For example, data describing targeting criteria and budget may include targeting type, targeted audience versus percentage spend of the budget, and percentage of ad spend versus conversion rate for the targeted audience.

The social networking system 100 identifies 415 one or more comparable completed advertising campaigns including targeting criteria associated with the initial targeting criteria. For example, social networking system 100 identifies 415 a completed advertising campaign having targeting criteria matching the initial targeting criteria and having a performance metric of a threshold value. In another example, social networking system 100 identifies 415 a completed advertising campaign having targeting criteria related to the initial targeting criteria and having a performance metric of a threshold value. In other embodiments, the social networking system 100 identifies a completed advertising campaign having a specified percentage or number of targeting criteria matching, or related to, the initial targeting criteria. Targeting criteria related to the initial targeting criteria may include targeting criteria that is similar to, or otherwise associated with, one or more of the initial targeting criteria.

In one embodiment, social networking system 100 identifies 415 a completed advertising campaign having targeting criteria similar to or comparable to the initial targeting criteria, and having an amount spent less than a threshold percentage of a budget of the completed advertising campaign. Similar or comparable targeting criteria may include targeting criteria with common demographic or geographic information, interest, preference, keyword, and the like. A threshold percentage of a budget of the completed campaign may include a completed campaign that consumed less than its entire campaign budget (i.e., has a percentage amount spent of less than one hundred percent). Generally, social networking system 100 may use any performance metric and associated threshold suitable for identifying information about a completed campaign suitable for predicting the amount spent for the received ad campaign.

In one embodiment, social networking system 100 weights targeting criteria of an ad campaign prior to identifying 415 one or more comparable completed advertising campaigns, thereby improving the accuracy of the predicted amount spent. For example, prior to identifying 415 completed advertising campaigns comparable to a received ad campaign featuring a trial membership for a new boot camp workout facility in Menlo Park, Calif., social networking system 100 assigns higher weights to the following targeting criteria for the ad campaign: work in Menlo Park, friends members of boot camp fitness program, checked-in at boot camp fitness program within the last six months. Social networking system 100 assigns lower weights to other targeting criteria associated with the received ad campaign, minimizing their impact in identifying completed ad campaigns having targeting criteria similar to the initial targeting criteria. In an embodiment, social networking system 100 assigns weights in accordance with one or more selections from advertiser 110. Alternatively or additionally, social networking system 100 assigns weights based on the subject matter of the ad campaign, the number of targeting criteria, or the size of the targeted group intended to receive the target ad campaign.

Social networking system 100 determines 420 an amount spent based on performance of the one or more comparable completed advertising campaigns. In one embodiment, the performance of a comparable completed advertising campaign is based at least in part on a number of social networking users satisfying targeting criteria included in the comparable completed advertising campaign and the percentage spent of an ad budget of the comparable completed advertising campaign. For example, social networking system 100 determines 420 an amount spent for a received ad or ad campaign by determining an average value of the amount spent for completed ad campaigns having comparable targeting criteria. In another example, social networking system 100 determines an average value of amounts spent by comparable completed advertising campaigns having a performance metric equaling or exceeding a performance threshold and having spent at least a threshold amount of their budgets of the comparable completed advertising campaigns. For example, the threshold amount of the budget spent may be between ninety percent and ninety-nine percent of the budget. However, any suitable threshold amount of the budget may be specified. In another example, social networking system 100 determines 420 a mean of the amount spent for the one or more comparable historical ad campaigns. In a further example, social networking system 100 determines 420 a median of the amount spent for the one or more comparable historical ad campaigns. In another example, social networking system 100 determines 420 the amount spent using a combination of performance metrics (e.g., percentage ad spend budget of one hundred percent, with a CTR of at least five percent, and a frequency of unique delivery of no more than five percent).

For one or more ad campaigns having comparable targeting criteria to a received ad campaign, social networking system 100 compares 425 the budget of the received ad campaign to the determined amount spent information for the comparable completed ad campaigns. Based on the comparison, social networking system 100 determines 430 a suggestion for modifying the initial targeting criteria for the ad campaign. For example, responsive to the budget for the received ad campaign exceeding the determined amount spent, social networking system 100 generates a suggestion to broaden the initial targeting criteria so more users of social networking system 100 are identified. Similarly, responsive to determining the budget is less than the determined amount spent, social networking system 100 generates a suggestion to narrow the initial targeting criteria so fewer users of social networking system 100 are identified.

In some embodiments, social networking system 100 generates a suggested modification to the initial targeting criteria by identifying a group of currently targeted users, and then segmenting the group based on one or more dimensions. Dimensions may include demographic, geographic, topical, or connection type information associated with users of social networking system 100. A segment includes users having one or more common characteristics. For example, a segment may include males, females, users associated with a geographic location (e.g., hometown, workplace, check-in location, indication of a plan to attend an event), or any other characteristic of a user of social networking system 100. Social networking system 100 chooses one or a combination of segments of the currently targeted group to suggest a modification to the initial targeting criteria. For example, a suggested modification to the initial targeting criteria may include a suggestion to expand, to narrow, or to otherwise modify an aspect of the initial targeting criteria (e.g., “expand initial targeting criteria to include users that work in Mountain View Calif. or Palo Alto Calif.,” “narrow initial targeting criteria to include only users ages 28-39,” or “include users that have indicated an interest in mountain biking and that have indicated interest in traveling to Utah”).

Social networking system 100 may use information about historical advertising campaigns to determine how to segment the group of currently targeted users and which segments to suggest. For example, social networking system 100 may use segmentation information associated with comparable completed advertising campaigns to determine how to segment the group of currently targeted users and which segments to suggest. The process of generating suggested modifications to a previous or an initial targeting criteria received from advertiser 110 may be iteratively applied by social networking system 100.

Social networking system 100 sends 435 the suggestion to an electronic device associated with advertiser 110. Social networking system 100 may receive a modified ad campaign from advertiser 110 in response to the advertiser 110 receiving the suggestion. For example, the modified ad campaign may include targeting criteria modified responsive to the suggestion. The modified targeting criteria may include more, less, or different criteria compared to the initial targeting criteria. Hence, social networking system 100 allows advertiser 110 to adjust the composition of the intended audience to consume the available budget allocated for the ad based on data from comparable ad campaigns that have been completed. This reduces wasteful ad spending by reducing the likelihood that an ad will saturate an intended audience, and reduces the time spent in the exploration stage to determine the right mix of targeting criteria and ad budget for an ad and/or ad campaign.

### SUMMARY

The foregoing description of embodiments has been presented for the purpose of illustration; it is not intended to be exhaustive or to limit this disclosure to the precise forms disclosed. Persons skilled in the relevant art can appreciate that many modifications and variations are possible in light of this disclosure.

Some portions of this disclosure describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also relate to an apparatus for performing the operations herein. This apparatus may be particularly constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of this disclosure be limited not by this detailed description, but rather by any claims that issue on an application based hereon. Accordingly, this disclosure is intended to be illustrative, but not limiting, of the scope of the embodiments set forth in the following claims.

What is claimed is:

1. A method comprising:
receiving an advertising campaign comprising one or more ads, a budget, and an initial targeting criteria defining one or more characteristics of users of a social networking system to receive one or more ads in the advertising campaign;
receiving data stored by the social networking system describing historical advertising campaigns including targeting criteria and budgets;
identifying one or more comparable completed advertising campaigns including targeting criteria associated with the initial targeting criteria;
determining an amount spent based on performance of a comparable completed advertising campaign based at least in part on a number of social networking users satisfying targeting criteria included in the comparable completed advertising campaign and the percentage of a budget of the comparable completed advertising campaign that was spent;
comparing the budget of the received advertising campaign to the amount spent determined from the one or more comparable completed advertising campaigns;
determining a suggestion for modifying the initial targeting criteria for the advertising campaign based on the comparison; and
sending the suggestion to an electronic device associated with the advertiser.

2. The method of claim 1, further comprising:
receiving a modified ad campaign from the advertiser, the modified ad campaign including targeting criteria modified responsive to the suggestion.

3. The method of claim 1, wherein the suggestion includes a suggestion to narrow the initial targeting criteria.

4. The method of claim 1, wherein the suggestion includes a suggestion to broaden the initial targeting criteria.

5. The method of claim 1, wherein determining the suggestion for modifying the targeting criteria comprises:
responsive to the determining the budget exceeds the amount spent, generating a suggestion to broaden the initial targeting criteria to identify more users of the social networking system; and
responsive to determining the budget is less than the amount spent, generating a suggestion to narrow the initial targeting criteria to identify fewer users of the social networking system.

6. The method of claim 5, wherein the suggestion to broaden the initial targeting criteria includes a suggested modification to the targeting criteria.

7. The method of claim 6, wherein the suggested modification includes a suggestion to broaden a range associate with the targeting criteria.

8. The method of claim 5, wherein the suggestion to narrow the initial targeting criteria includes a suggested modification to the targeting criteria.

9. The method of claim 8, wherein the suggested modification includes a suggestion to a narrow a range associated with the targeting criteria.

10. The method of claim 1, wherein generating the suggestion for modifying initial targeting criteria comprises:
identifying a group of currently targeted users satisfying one or more characteristics from the initial targeting criteria;
segmenting the group of currently targeted users into one or more segments, so that users in a segment have at least one common characteristic; and
choosing one or more segments to suggest a modification to the initial targeting criteria.

11. The method of claim 10, wherein the at least one common characteristic comprises at least one of demographic, geographic, topical, or connection type information associated with users of the social networking system.

12. The method of claim 10, wherein the at least one common characteristic is determined from targeting criteria included in one or more comparable completed advertising campaigns including targeting criteria associated with the initial targeting criteria.

13. The method of claim 10, wherein the modification includes narrowing the initial targeting criteria.

14. The method of claim 10, wherein the modification includes broadening the initial targeting criteria.

15. The method of claim 1, wherein identifying one or more comparable completed advertising campaigns including targeting criteria associated with the initial targeting criteria comprises:
identifying a completed advertising campaign having targeting criteria matching the initial targeting criteria and having a performance metric of a threshold value.

16. The method of claim 15, wherein the performance metric comprises a frequency with which ads from the completed advertising campaign were delivered to unique users of the social networking system.

17. The method of claim 15, wherein the performance metric comprises a click-through rate for ads in the completed advertising campaign.

18. The method of claim 1, wherein identifying one or more comparable completed advertising campaigns including targeting criteria associated with the initial targeting criteria comprises:
identifying a completed advertising campaign having targeting criteria related to the initial targeting criteria and having a performance metric of a threshold value.

19. The method of claim 1, wherein identifying one or more comparable completed advertising campaigns including targeting criteria associated with the initial targeting criteria comprises:
identifying a completed advertising campaign having targeting criteria similar to the initial targeting criteria, and having a spent less than a threshold percentage of a budget of the completed advertising campaign.

20. The method of claim 1, wherein historical advertising campaign data comprises, for a served ad:
targeting type, targeted audience versus percentage spend of the budget, and percentage of ad spend versus conversion rate for the targeted audience.

21. The method of claim 1, wherein determining the amount spent comprises:
determining an average value of amounts spent by the comparable completed advertising campaigns.

22. The method of claim 1, wherein determining the amount spent comprises:
identifying comparable completed advertising campaigns having a performance metric equaling or exceeding a performance threshold and having spent at least a threshold amount of the budget of the comparable completed advertising campaign; and
determining an amount spent by the identified comparable completed advertising campaigns.

23. The method of claim 22, wherein the threshold amount of the budget is between ninety percent and ninety-nine percent of the budget.

24. The method of claim 1, wherein determining the amount spent comprises:
determining an amount spent based on one or more comparable completed advertising campaigns having one or more specified performance metrics.

25. A method comprising:
receiving an advertising campaign from an advertising system, the advertising campaign comprising one or more ads, a budget and an initial targeting criteria defining one or more characteristics of users of a social networking system to receive one or more ads from the advertising campaign;
retrieving data stored by the social networking system describing historical advertising campaigns including targeting criteria and budgets;
identifying one or more comparable historical advertising campaigns including targeting criteria associated with the initial targeting criteria and having spent less than their budgets;
determining an amount spent for the one or more comparable historical advertising campaigns;
if the budget exceeds the amount spent, sending a recommendation to broaden the targeting criteria to the advertising system; and
if the budget is less than the amount spent, sending a recommendation to narrow the targeting criteria to the advertising system.

26. The method of claim 25, wherein determining the amount spent for the one or more comparable historical advertising campaigns includes calculating a mean of the amount spent for the one or more comparable historical advertising campaigns.

27. The method of claim 25, wherein determining the amount spent for the one or more comparable historical advertising campaigns includes calculating a median of the amount spent for the one or more comparable historical advertising campaigns.

28. A method comprising:
receiving an advertising campaign from an advertising system, the advertising campaign comprising one or more ads, a budget and an initial targeting criteria defining one or more characteristics of users of a social networking system to receive one or more ads from the advertising campaign;
retrieving data stored by the social networking system describing historical advertising campaigns including targeting criteria and budgets;
identifying one or more comparable historical advertising campaigns including targeting criteria associated with the initial targeting;
a step for determining an amount spent by the comparable historical advertising campaigns;
if the budget exceeds the amount spent, sending a recommendation to broaden the targeting criteria to the advertising system; and
if the budget is less than the amount spent, sending a recommendation to narrow the targeting criteria to the advertising system.
